(19) United States
(12) Patent Application Publication
(10) Pub. No.: US 2009/0094372 A1
(43) Pub. Date: Apr. 9, 2009

(54) SECRET USER SESSION MANAGING METHOD AND SYSTEM UNDER WEB ENVIRONMENT, RECORDING MEDIUM RECORDED PROGRAM EXECUTING IT

(76) Inventors: DaeHun Nyang, Seoul (KR); YoungJae Maeng, Seoul (KR); JeonIl Kang, Gongju-si (KR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/965,941

(22) Filed: Dec. 28, 2007

(30) Foreign Application Priority Data
Oct. 5, 2007 (KR) 10-2007-0100637
Oct. 5, 2007 (KR) 10-2007-0100638

(51) Int. Cl. G06F 15/16

(52) U.S. Cl. 709/229

(57) ABSTRACT

The present invention provides a secure user session managing method and system between a client and a server connected through network in web environment. The user session managing method includes: allowing the server to receive a first HTTP request including a cookie from the client, wherein the cookie includes a client authentication value and the client authentication value is calculated by using a shared key stored in the client and session information included in a HTTP response transmitted right before to the client; comparing a server authentication value with the client authentication value included in the cookie, wherein the server authentication value is calculated by employing the session information and the shared key stored in the server; and determining a transmitter's authentication failure or success of the client according to the result of the comparison. User session can be secured by applying the challenge-response authentication algorithm to the HTTP protocol.

### CROSS-REFERENCE TO RELATED APPLICATION

This application claims the benefit of Korean Patent Application No. 10-2007-0100637 filed with the Korean Intellectual Property Office on Oct. 5, 2007 and Korean Patent Application No. 10-2007-0100638 filed with the Korean Intellectual Property Office on Oct. 5, 2007, the disclosures of which are incorporated herein by reference in their entirety.

### BACKGROUND

1. Technical Field

The present invention relates to a secure user session managing method and system.

2. Description of the Related Art

Web environment is an open system environment for providing web services to many and unspecified users who linked thereto. Session in web services means information stored and received/transmitted in a server and a client for providing a series of services continuously requested by a user in HTTP (Hypertext Transfer Protocol: a communication protocol used to transfer or convey information between a web server and a user's internet browser on internet) which status information is not kept.

A client conventionally selects and authenticates users using a cookie in order to manage user sessions under web environment. As an example, user IP, user password hashed and electronic signature, or the like is used in the cookie.

However, whenever HTTP requests are requested, a cookie in a client is automatically transmitted in a plaintext form to a server and thus information included in the cookie can be exposed to an attacker. Protection of user sessions is poor from IP spoofing or offline dictionary attack by using cookies.

Thus, the cookie used in the user session management is easily exposed outside through sniffing, etc. ActiveX used to resolve such problems also has some drawbacks such as heavy burden on users or inconveniences. When any problem occurs in installation of ActiveX, it may cause no access to web services.

### SUMMARY OF THE INVENTION

The present invention provides a user session managing method which allows the session protection of a user by employing a challenge-response authentication algorithm to a HTTP protocol.

Further, the present invention provides a user session managing method which can prevent automatic transmission of cookies in a plaintext form, which is a drawback associated with the conventional use of cookies, by storing a secure key in a separate storage space, not in a cookie.

Further, the present invention provides a user session managing method which can reduce errors by employing a reverification routine of a shared key when a random number is not synchronized due to user's behavior patterns or network conditions, in the use of the challenge-response method to the HTTP protocol.

Even further, the present invention provides a user session managing method which allows much more flexible responses to concurrent or simultaneous HTTP requests by employing a threshold time.

### BRIEF DESCRIPTION OF THE DRAWINGS

FIG. 1 is an authentication method of a challenge-response protocol applied to the present invention.

FIG. 2 is a block diagram illustrating a session managing module included in a server according to an embodiment of the present invention.

FIG. 3 illustrates a secure user session managing method and a transmitter authentication protocol of a HTTP request.

FIG. 4 illustrates another secure user session managing method and a transmitter authentication protocol of a HTTP request in a key protection mode.

FIG. 5 is a block diagram illustrating a session managing module included in a server according to another embodiment of the present invention.

FIG. 6a illustrates a secure user session managing method according to another embodiment of the present invention.

FIG. 6b illustrates an opinion code executing in the server of FIG. 6a.

FIG. 7a illustrates a secure user session managing method according to another embodiment of the present invention.

FIG. 7b illustrates an opinion code executing in the server of FIG. 7a.

### DESCRIPTION OF THE EMBODIMENTS

The descriptions set forth below merely illustrate the principles of the present invention. Therefore, those skilled in the art could devise various methods and apparatus thereof which realize the principles of the present invention and which do not depart from the spirit and scope of the present invention, even though they may not be clearly explained or illustrated in the present specification. Also, it is to be appreciated that not only the principles, viewpoints, and embodiments of the present invention, but all detailed descriptions listing the particular embodiments are intended to include structural and functional equivalents.

Terms used in the description (for example, a first, a second, etc.) are merely used to distinguish equal or similar items in an ordinal manner.

Also, the terms used in the description are merely used to describe the following embodiments, but not to limit the invention. Unless clearly used otherwise, expressions in the singular number include a plural meaning. In this application, the terms “included” and “stored” intend to express the existence of the characteristic, the numeral, the step, the operation, the element, the part, or the combination thereof, and do not intend to exclude another characteristic, numeral, step, operation, element, part, or any combination thereof, or any addition thereto.

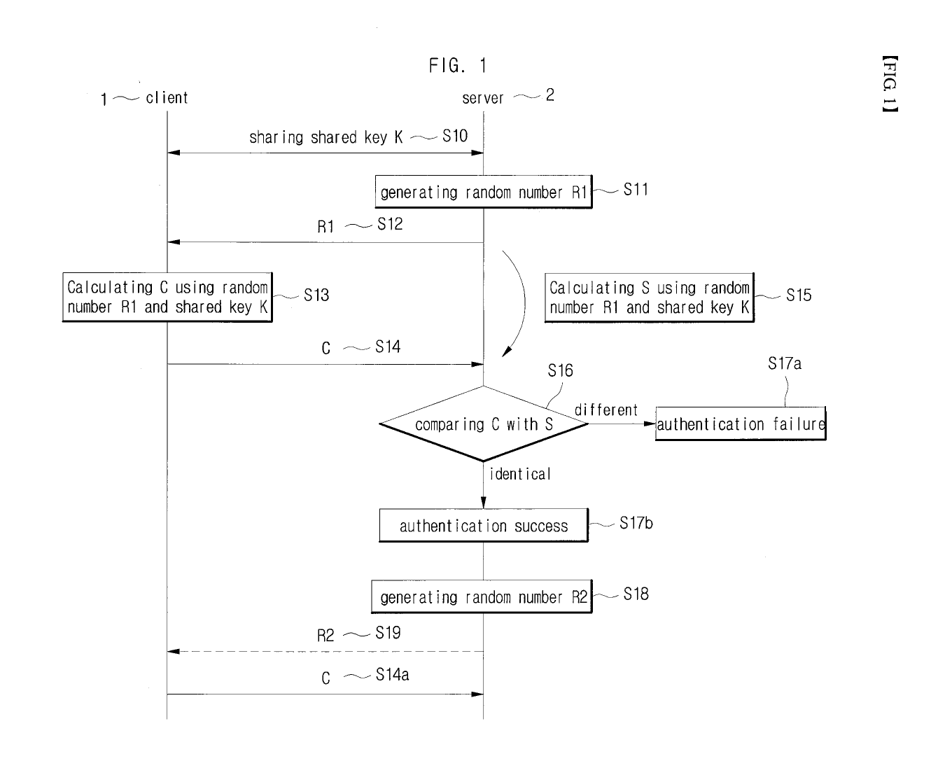

FIG. 1 illustrates an authentication method of a challenge-response protocol applied to the present invention. A secure key is used for a client 1 to calculate a client authentication value and for a server 2 to calculate a server authentication value, and a shared key is shared by the client 1 and the server 2 when the first user logs in.

The client 1 and the server 2 share each other a secure key K between the client 1 and the server 2 in Step 10. The secure key K is here a shared key. The shared key K may be shared when a user logs in to the server 2 through the client 1 by using a secure key exchange protocol such as a password authenticated key exchange(PAKE), etc.

The server 2 generates a random number R1 in Step 11 and stores the random number R1 using a session and the like. The generated random number R1 is then transmitted to the client 1 in Step 12. This transmission process of the random number R1 to the client 1 is called as a challenge process.

The client 1 calculates a client authentication value C by employing the random number R1 received from the server 2 and the shared key K pre-stored in the client 1 in Step 13. The client authentication value C by employing the random number R1 and the shared key K is calculated with a one-way function. The one-way function is a function that is easy to compute but hard to invert and examples thereof include hash function, pseudo-random number function and the like.

The client 1 transmits the produced client authentication value C to the server 2 in Step 14. This transmission of the client authentication value C to the server 2 is called as a response process.

The server 2 calculates a server authentication value S by employing the random number R1 and the shared key K pre-stored in the server 2 in Step 15 at an appropriate time from after the generation of the random number R1 in Step 11 to right before Step 16. The server authentication value S is calculated with a one-way function which may be the same one-way function used by the client 1.

The server 2 compares the server authentication value S in the server 2 with the client authentication value C received from the client 1 in Step 16.

When the client authentication value C is different from the server authentication value S, it would be detected by an authentication failure since it is determined that the shared key K of the client 1 is different from the shared key K of the server 2 in Step 17a, and the user session would be deleted since the user session is not valid.

When the client authentication value C is identical to the server authentication value S, it would be detected by an authentication success since it is determined that the shared key K of the client 1 is identical to the shared key K of the server 2 in Step 17b, and the user session is kept being valid. A new random number R2 is then generated in Step 18. The challenge-response process from Step 12 to Step 16 may be repeated with the new generated random number R2. Thus, the challenge-response process described in the present invention is applied to the HTTP protocol so that it provides a secure user session managing method and system under web environment.

User Session Managing Method I:

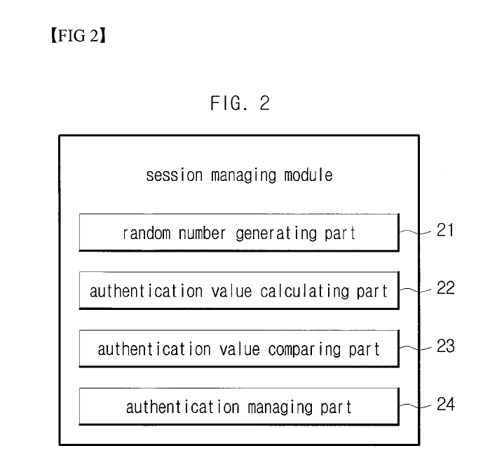

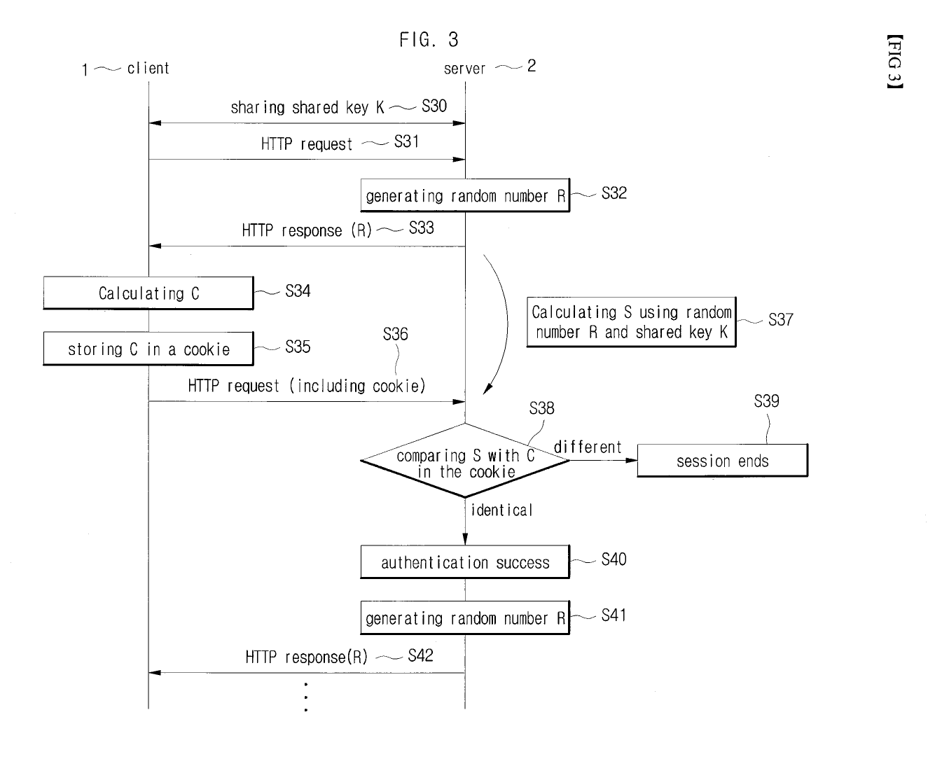

FIG. 2 is a block diagram illustrating a session managing module contained in a server according to an embodiment of the present invention and FIG. 3 is a secure user session managing method and a transmitter authentication protocol of a HTTP request according to an embodiment of the invention.

Referring to FIG. 2, the session managing module includes a random number generating part 21, authentication value calculating part 22, authentication value comparing part 23, and authentication managing part 25.

The session managing module is contained in the server 2. The session managing module manages sessions for transmitter's authentication to HTTP requests from the client 1.

The random number generating part 21 generates a random number to be shared with the client 1.

The authentication value calculating part 22 calculates a server authentication value with a predetermined function by employing the generated random number and a shared key, etc already stored.

The authentication value comparing part 23 compares the server authentication value calculated by the authentication value calculating part 22 with the client authentication value received from the client 1 which is a value calculated with a predetermined function by employing the random number and the shared key by the client 1.

The authentication managing part 24 determines an authentication success or failure of the client 1 which requests for the HTTP request according to the comparison result. If the authentication is failure, the authentication managing part 24 deletes a session by determining that the HTTP request is from an unfavorable client 1. If the authentication is success, the authentication managing part 24 keeps a session by determining that the HTTP request is from a favorable client 1.

An operation of the session managing module and a process of HTTP request and HTTP response in the user session managing system of the present invention including the client 1 and the server 2 connected through the network is described in more detail hereinafter with referring to FIG. 3. The session managing module is represented by the server 2 for convenience.

The client 1 and the server 2 share a secure key K between the client 1 and the serer 2 each other in Step 30. That is, the secure key K is a shared key. The shared key K may be shared when a user logs in to the server 2 through the client 1 by using a password key exchange protocol(e.g., PAKE, etc.).

The shared key K is stored in a web browser from log in stage of the client 1 to log out stage and maintained even though a web page changes.

Here, in case that the shared key K is, stored in a cookie, the HTTP request including the cookie may be sent to the network with a HTTP request from the client 1, which causes exposure of the shared key as it is.

Thus, the client 1 stores the shared key K in a separate storage space instead of the cookie. Window.name, local shared object(LSO) of flash or activeX, etc. among window object properties of document object model(DOM) of a web browser may be used as the separate storage space. Such separate storage spaces will be described in detail below.

The server 2 operates as follows when a HTTP request is received from the client 1.

The server 2 generates a random number R in Step 32 and a pseudo code relating thereof is as follows.

R=random( )

The server 2 calculates a server authentication value S with a predetermined function by employing the random number R and the shared key K in Step 37. Here, user identification information such as ID may be further used as a factor of the predetermined function. A pseudo code relating thereof is as follows.

S=Func(K, R, ID, . . . )

Here, the predetermined function may be a one-way function. The one-way function is a function that is easy to compute but hard to invert and examples thereof include hash function, pseudo-random number function and the like.

The server 2 stores the shared key K, the random number R, and the server authentication value S in a session or database provided by a web application. A pseudo code relating thereof is as follows.

Session={K, R, S}

The Step 37 may be performed anytime between after Step 32 and prior to Step 38 in the server 2.

The server 2 transmits the random number R generated in Step 32 to the client 1 through a HTTP response in Step 33. The random number R is session information. Here, the session information is information that the server 2 provides to the client 1 for a user session authentication.

The client 1 calculates a client authentication value C with a predetermined function by employing the received random number R and the shared key K stored in the separate storage space in Step 34. Here, ID and the like as a user's identification information may be further used as a factor of the predetermined function. The predetermined function should be the same with the one-way function used by the server 2 in Step 37.

The client 1 stores the calculated client authentication value C in a cookie in Step 35. A pseudo code relating thereof is as follows.

setCookie(C=Func(K, R, ID, . . . ))

The cookie storing the client authentication value C is automatically included in a HTTP request and transmitted to the server 2 with a HTTP request of the client 1 in Step 36.

The server 2 compares the client authentication value C contained in the cookie and the server authentication value S calculated in Step 37, in Step 38. When the two authentication values are different each other, it proceeds to Step 39 and when they are identical, it proceeds to Step 40.

In Step 39, the server 2 determines an authentication failure since two authentication values are different, and deletes session maintaining information (random number R, shared key K, etc.) of the server side and deletes also the session. A pseudo code relating thereof is as follows.

Session destroy( )

The server 2 transmits client side script, flash or activeX to the client to establish all of client side session management information (shared key K, random number R, cookie, etc) stored in the client into NULL. In this process, a user is logged out.

The server 2 determines an authentication success of the client 1 since two authentication values are identical in Step 40 and generates a new random number R in Step 41. The server 2 transmits a HTTP response including the new generated random number to the client 1 through a HTTP request in Step 42. Here, when the server 2 receives another HTTP request, Step 38 and below processes are repeated.

The client 1 stores the shared key K exchanged in Step 30 in a separate storage space instead of the cookie. Window.name, local shared object(LSO) of a flash or activeX, etc. among window object properties of document object model(DOM) in a web browser may be used as the separate storage space.

According to an embodiment, the storage space in the client 1 may be window.name of window object properties of a document object model in a web browser. Here, the document object model(DOM) is an object-based document model for inter-working of extensible markup language(XML) data through a web browser. DOM is a platform- and language-neutral interface that allows programs and scripts to access and update the content, structure, and style of documents and connects web pages to scripts or programming languages. DOM is an object-oriented representation of properties, methods and events used to retrieve and modify the web page and such objects are accessible through script languages in most of web browsers.

Window.name provides a name to each browser (or tap) and allows access between browsers through such names. Even though a page within a browser is changed, the name of a browser is not changed so that it is being recently used to deliver data between pages. Any desired data may be saved without limitation since window.name has no particular limit on size to write, which is another advantage in the use of window.name.

According to another embodiment, a storage space in the client 1 may be a local shared object (LSO) of flash. LSO is a cookie-like data entity used in a flash player. The application running in the flash player can store and retrieve date, which is composed of basic data types such as strings or numbers or more complex objects. LSO of flash is a space to be used if flash plug-in is installed. Unlike the above embodiment that a variable name is assigned as window.name, variable names can be assigned as wanted and data can be managed by domain like cookies, so that it can be more secure. A general size to save data in LSO is 100 KB.

According to another embodiment, the client 1 may store the shared key K using activeX. ActiveX is a plugin for Internet Explorer and allows install compiled programs in a user's computer so that the user can use much more sources of a client.

A user can store and read at the place where a provider installed with activeX. ActiveX documents, active scripting, etc., as part of the activeX technologies, may provide storage spaces. ActiveX documents may be able to view non-HTML documents such as MS Word or Excel files, etc. Active scripting is a script language which may be adopted to activeX controls or Java applets and J script and VB script are most typical languages.

When a shared key, which is a secure key, is stored in such storage spaces, this secure key may be exposed in public and causes difficulty in secure session managing. For example, window.name can store data with no limitation in size but when a secure key is stored in the window.name, it may cause a problem of security concerns since the value is not changed with moving into another service. Here, to avoid such a problem, a modified or encrypted key in a way that is not recognized, instead of storing a secure key, may be stored and thus even though a value stored in window.name is exposed, the secure key is not directly exposed.

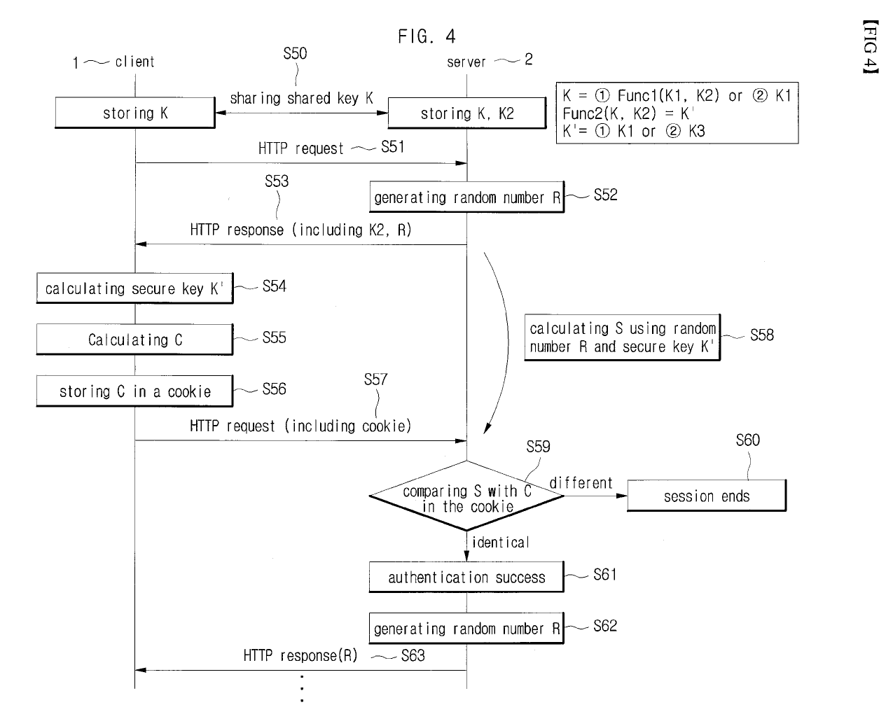

Hereinafter a case that a secure key and a shared key are different each other will be described in more detail with referring to FIG. 4.

FIG. 4 illustrates another secure user session managing method and a transmitter authentication protocol of a HTTP request in a key protection mode.

That is, the key protection mode means that it allows transmitter authentication of a HTTP request since even though a shared key is exposed, a secure is not exposed. Unlike the description explained with referring to FIG. 3, a secure key and a shared key are different each other.

A client 1 and a server 2 share a shared key K between the client 1 and the server 2 each other in Step 50. The shared key K can be shared when a user logs in for web services to the server 2 through the client 1 by using a password key exchange protocol such as PAKE, etc.

The shared key K should be stored in a web browser from the login stage of the client 1 to the logout stage and it should be maintained even web pages change.

Here, when the shared key is stored in a cookie, it can be exposed as it is with a HTTP request from the client 1 since it transmits through the network.

Therefore, the client 1 stores the shared key K in a separate storage space instead of a cookie. Window.name, local shared object(LSO) of a flash or activeX, etc. among window object properties of document object model(DOM) of a web browser may be used as the separate storage space. Such separate storage spaces have been described above and detailed descriptions are thus omitted.

Here, the shared key K has the properties of the following equation 1 to be applied to key protection mode:

K=\textcircled{1}Func1(K1, K2) or \textcircled{2}K1

Func2(K, K2)=K′

K′=\textcircled{1}K1 or \textcircled{2}K3 Equation 1

wherein K is a shared key, K′ is a secure key, Func 1 is a key transfer function to transfer a secure key using a key transfer factor K2 to a key not to be exposed as it is, Func2 is a secure key generating function for generating a secure key K′ from the shared key K using a key transfer factor K2.

The client 1 stores only the shared key K, the server 2 stores the shared key K and the key transfer factor K2. Even though the shared key K stored in the client 1 and/or the key transfer factor K2 are exposed outside, the secure key is protected since the new secure key K′ is generated by employing the shared key K and the key transfer factor K2.

According to a first embodiment \textcircled{1}, K1 is a secure key (K′=K1).

The client 1 and the server 2 share the shared key K which is transferred by employing the key transfer function Func 1 and the key transfer factor K2 so that the secure key K1 is not exposed. Here, the secure key generating function Func2 is a function to recover the secure key K1 with the transferred key K through the key transfer function Func 1.

Therefore, the client 1 calculates a client secure key K′, which is K1, obtained with the secure key generating function Func2 by employing the shared key K and the key transfer factor K2 and uses this secure key to generate client side session maintaining information for the transmitter authentication. The server 2 calculates a server secure key K′, which is K1, obtained with the secure key generating function Func2 by employing the shared key K and the key transfer factor K2 and uses this server secure key to generate server side session maintaining information for the transmitter authentication.

According to a second embodiment \textcircled{2}, K1 is a shared key (K′=K3).

When the shared key K is K1, a secure key K3, which is obtained with the key generating function Func2 by employing K1 and the key transfer factor K2 is generated a s secure key. Thus, the client 1 calculates a client secure key K′, which is K3, obtained with the secure key generating function Func2 by employing the shared key K1 and the key transfer factor K2 and uses this secure key to generate client side session maintaining information for the transmitter authentication. The server 2 also calculates a server secure key K′, which is K3, obtained with the secure key generating function Func2 by employing the shared key K1 and the key transfer factor K2 and uses this secure key to generate server side session maintaining information for the transmitter authentication.

A method for the transmitter authentication is described hereinafter by assuming that the client 1 and the server 2 share the shared key K through the password key exchange protocol in Step 50.

The server 2 receives a HTTP request from the client 1 in Step 51 and generates a random number R in Step 52. A pseudo code relating thereto is as follows.

R=random( )

The server 2 calculates a server authentication value S with a predetermined function by employing the random number R and the server secure key K′ in Step 58. Here, the server secure key K′ is pre-obtained with the secure key generating function Func2 by employing the shared key K and the key transfer factor K2.

Here, user identification information such as ID may be further included as a factor of the predetermined function. A pseudo code relating thereto is as follows.

S=Func(K′, R, ID, . . . )

Here, the predetermined function may be a one-way function and examples of the one-way function include hash function, and pseudo random number function, etc.

The server 2 stores the shared key K, the key transfer factor K2, the random number R and the server authentication value S in a session or database provided in web applications. A pseudo code relating thereto is as follows.

Session={K, K2, R, S}

The Step 58 may be performed anytime between after Step 52 and prior to Step 58 in the server 2.

The server 2 transmits the random number R generated in Step 52 and the key transfer factor K2 to the client 1 through a HTTP response in Step 53. The random number R and the key transfer factor K2 are session information. Here, the session information is information that the server 2 provides to the client 1 for a user session authentication.

An executable code (e.g., Java scripts, etc.) which performs to calculate a client secure key K′ by employing the shared key K and the key transfer factor K2 and to calculate a client authentication value C, which is client side session maintaining information, from the client secure key K′, and to store the calculated client authentication value C in a cookie, may be further included in the HTP response.

The client 1 calculates a client secure key K′ with the secure key generating function Func2 by employing the key transfer factor K2 received and the shared key K stored in the separate storage space in Step 54.

The client 1 then calculates a client authentication value C, which is client side session maintaining information, with a predetermined function by employing the received random number R and the client secure key K′ calculated in Step 54, in Step 55. Here, user identification information such as ID may be further included as a factor of the predetermined function. The predetermined function should be the same as the one-way function used by the server 2 in Step 58.

The client 1 then stores the client authentication value C in a cookie in Step 56. A pseudo code relating thereto is as follows.

setCookie(C=Func(K′, R, ID, . . . ))

Here, right after storing the client authentication value C in the cookie, everything except the shared key K is deleted not to be exposed outside.

When the client 1 requests for a HTTP request for authentication, the HTTP request may include new client side session maintaining information and is then transmitted to the server 2. That is, the cookie storing the client authentication value C is automatically included into the HTTP request which is then transmitted to the server 2 in Step 57.

The server 2 compares the client authentication value C included in the cookie with the server authentication value S calculated in Step 58, in Step 59. When two authentication values are different each other, it proceeds to Step 60, while when two authentication values are identical, it proceeds to Step 61.

In Step 60, when two authentication values are different each other, the secure key and the client secured key are different, so that the server 2 determines authentication failure of the client 1 and deletes the server side session maintaining information (random number R, shared key K, key transfer factor K2, etc.) and the session. A pseudo code relating thereto is as follows.

Session destroy( )

The server 2 transmits a client side script, flash or activeX to the client 1 to set the client side session maintaining information (shared key K, key transfer factor K2, random number R, cookie, etc) stored in the client 1 to NULL. In this process, a user is logged out.

When two authentication values are identical, the server secure key and the client secure key are also identical, so that the server 2 determines authentication success of the client 1 in Step 61 and generates a new random number R in Step 62. The server 2 transmits a HTTP response for the HTTP request requested by the client with the new generated random number R and the key transfer factor K2 to the client 1 in Step 63. After this, when the server 2 receives another HTTP request, the processes after Step 59 are repeated.

When the above-mentioned user session managing method is used, the user session itself may be secured but HTTP details transmitted/received may be attacked. In order to protect the received/transmitted details from intrusion, important content(s) (for example, accounting number in an internet banking service) may be encrypted using a secure key shared between the client 1 and the server 2, wherein encryption is performed using an encryption routine of advanced encryption standard(AES).

When the server 2 sends the HTTP response, an important content is encrypted by using the secure key and the server 2 transmits the HTTP response with client side script, flash or activeX in order to decrypt the encrypted content in the client 1, to the client 1.

When the client requests a HTTP request, the server 2 transmits the corresponding HTTP response with an encryption routine to encrypt an important content using the secure key. Here, when the client 1 generates the HTTP request, the client 1 can encrypt the important content in the HTTP contents using the secure key according to the encryption routine.

The client 1 and the server 2 share the secure key or the shared key, which is able to generate the secure key, so that it is obvious to those skilled in the art that the encrypted content can be easily decrypted.

Such an encryption of a part of HTTP contents has the following difference from the encryption using the conventional secure sockets layer(SSL). SSL provides transport layer security, encrypts a whole contents, and has difficulties for session managing between domains, while the above-described encryption is on the application layer which encrypts using the secure key being shared by both the client 1 and the server 2 and allows selective encryption for a part of the HTTP contents and session managing between domains.

Further, when window.name is used as a storage space for the shared key and its child window is used, the shared key stored in the parent window may be shared in the child window by using a method of window.name-opener.name, in which opener.name is a window name of the parent window.

User Session Managing Method II:

Referring to FIG. 1, when a new random number R2 is transmitted from the server 2 to the client 1, the client authentication value C corresponding to a random number R1 previously transmitted to the client 1 may be transmitted back to the server 2 from the client 1 before the new random number R2 is delivered to the client 1 in Step 14a.

In this case, since the server 2 generated the new random number R2, a server authentication value is a value corresponding to the new random number R2 and the client authentication value C is a value corresponding to the random number R1, and thus the random number shared between the client 1 and the server 2 may not be synchronized.

When the challenge-response protocol shown in FIG. 1 is applied to the HTTP protocol in the present invention, since the random number shared by the client 1 and the server 2 may not be synchronized due to user's behavior patterns or network conditions, it is necessary to be prepared such situations. Here, the user's behavior pattern may be use of multiple web browsers or concurrent or simultaneous service requests, etc and network conditions may be delay or loss of packets.

Such a user's behavior pattern or network conditions may cause delay or loss of HTTP requests or HTTP responses. When a HTTP response is delayed or lost, even though the server 2 updates a random number corresponding to a HTTP request, a HTTP request corresponding to an un-updated random number may be transmitted since the updated random number is not transmitted or delayed the transmission to the client 1. As a result, the random number shared between the client 1 and the server 2 may not be synchronized.

When an authentication is failed for that the random number is not synchronized, since the challenge-response method is for verifying the shared key, a simple executable code such as client side script, flash or activeX, etc. is transmitted to the client 1 to reverify the shared key. A number of reverification of the shared key is limited and when it exceeds a particular number, the server 2 deletes a user session and logs out. Here, the reverification may be charged to the client 1 so that the burden on the reverification can be reduced

Further, HTTP requests can be made concurrently or simultaneously in the web environment. In one data, another data, for example, can be included. In this case, a HTTP request and a HTTP response may be messed. Thus, after the first HTTP request, HTTP requests which arrive within a certain time may have the same client authentication value with that for the first HTTP request. HTTP responses thus may be made more flexibly against simultaneous HTTP requests within a short period of time by extending a time for having the corresponding client authentication value.

Hereinafter, a secure user session managing method applied in the above-described condition in the web environment will be provided.

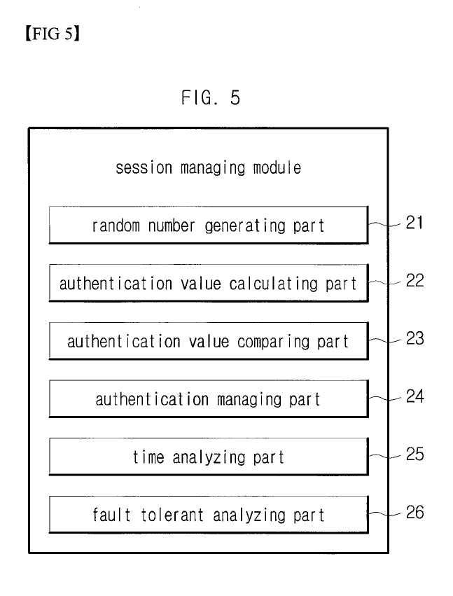

FIG. 5 is a block diagram illustrating a session managing module included in a server according to another embodiment of the present invention. Referring to FIG. 5, a session managing module includes a random number generating part 21, an authentication value calculating part 22, an authentication value comparing part 23, an authentication managing part 24, a time analyzing part 25, and a fault tolerant analyzing part 26. The random number generating part 21, the authentication value calculating part 22, the authentication value comparing part 23, and the authentication managing part 24 are explained with referring to FIG. 2 and thus a time analyzing part 25 and a fault tolerant analyzing part 26 are explained in more detail hereinafter.

The time analyzing part 25 determines as concurrent or simultaneous service requests and provides HTTP responses without updating a random number when HTTP requests transmitted from the client 1 within a certain time(for example, threshold time, etc.) have the same client authentication value and the client authentication value is identical to a first server authentication value.

When the client authentication value is identical to a second server authentication value, it is determined that the HTTP request applied with a pre-generated random number ends and a HTTP request applied with a newly generated random number is received. In this case, the second server authentication value is copied in the first server authentication value. The new random number is generated, the new second server authentication value is calculated, and the newly generated random number is included into the HTTP response to be transmitted to the client 1.

When HTTP requests from the client 1 are not continuously arrived within a certain time and the client authentication value is different from the second server authentication value, most of corresponding HTTP requests are HTTP requests by an attacker. However, it may be an error caused by desyncronization of a random number due to a user's behavior pattern or network conditions as described above, even if the client 1 and the server 2 have the same shared key.

The fault tolerant analyzing part 26 uses a reverification routine of the shared key in order to accept such tolerances. Within a certain time and/or for a certain number of times, a random number is transmitted to the client 1 and a HTTP response, which allows immediate transmission of the client authentication value calculated corresponding to the random number as a HTTP request, is transmitted to the client 1. The fault tolerant analyzing part 26 reverifies if the client 1 has the shared key by comparing the client authentication value included in the HTTP request with the first server authentication value or the second server authentication value.

A user session managing method, that resolves a problem in the determination if the client 1 has a shared key from the server 2 because of the desyncronization of session information (random number in FIG. 3, random number and key transfer factor in FIG. 4) under the conditions of user's behavior patter or network environment, will be described.

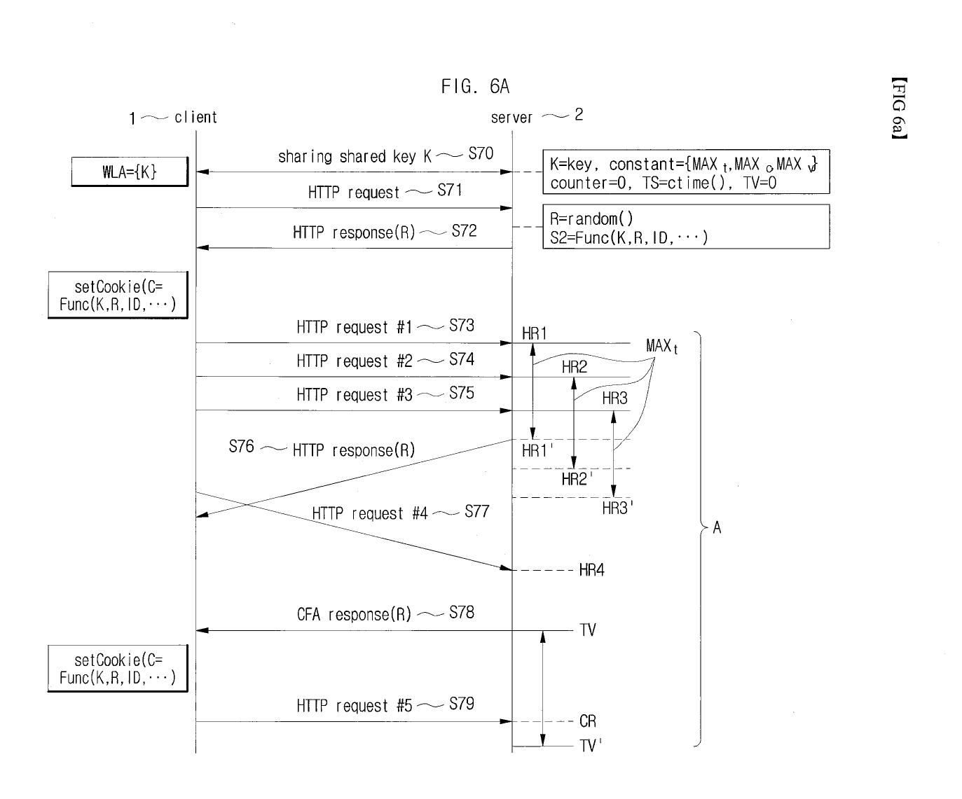

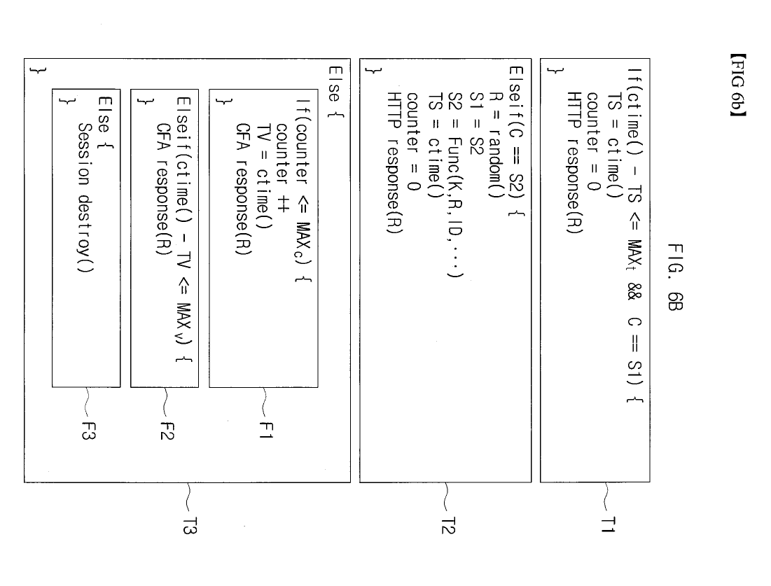

FIG. 6a illustrates a secure user session managing method according to another embodiment of the present invention. FIG. 6b is pseudo code executing in the server of FIG. 6a.

A client 1 and a server 2 share a shared key K by using a secure key exchange protocol (e.g., PAKE, etc.) in Step 70. This applies when a user logs in to web services.

Here, the client 1 stores the shared key K in a certain storage space(WLA: window.name, local shared object(LSO) of a flash or activeX, etc.).

The server 2 also stores maximum threshold time(MAXt), maximum threshold counter(MAXc), constant of maximum verification threshold time(MAXv), counter, timestamp(TS), and variable of verification timestamp(TV), besides the shared key K.

An initial value of each variable is as follows:

counter=0, TS=ctime( ), TV=0

wherein ctime( ) is a function representing a current time.

Here, a first server authentication value S1 is initialized to a random value. When the first server authentication value S1 is updated to a second server authentication value S2, a second server authentication value S2 before updated is copied.

When a HTTP request is received from the client 1 in Step 71, the server 2 generates a random number R and calculates a second server authentication value S2 with a predetermined function by employing the generated random number R and the shared key K stored in the server 2. The predetermined function is a one-way function. User identification information such as ID may be further included as a factor of the predetermined function.

The server 2 transmits a HTTP response including the random number R, generated in Step 71, to the client 1 in Step 72.

The server 2 stores the first server authentication value S1, the second server authentication value S2, and the random number R corresponding to the second server authentication value S2 in a session or database provided in web applications.

The client 1 receives the HTTP response transmitted in Step 72. Only when the random number R included in the HTTP response is different from a random number pre-stored in the certain storage space, the client 1 calculates a client authentication value C with a predetermined function by employing the random number included in the HTTP request and the shared key K stored in the client 1. The predetermined function is the same as the one-way function used in the server 2. User identification information ID may be further included as a factor of the predetermined function. The random number R included in the HTTP response is copied in the certain storage space.

The client authentication value C is stored in a cookie. The cookie automatically included in a head of the client authentication value is transmitted to the server 2 in Step 73.

When the client authentication value C included in the cookie is identical to the first server authentication value S1 in the server and ctime( )-TS is within the maximum threshold time(MAXt), the server 2 performs a pseudo code module T1 which is time flexible routine. The maximum threshold time(MAXt) may be a time to group continuous HTTP responses to one simultaneous HTTP responses group.

Current time(ctime( )) is stored into the timestamp(TS) in a time flexible routine(T1). This can be a standard to determine if post continuous HTTP responses are arrived within the maximum threshold time. The counter is initialized to zero. The counter will be described in a reverification routine T3. The counter also transmits the HTTP response with the random number R, which is currently stored in the server 2, to the client 1 in Step 76.

It is assumed that a HTTP request #1 in Step 73, a HTTP request #2 in Step 74, a HTTP request #3 in Step 75, and a HTTP request #4 in Step 77 is grouped as one simultaneous HTTP responses group.

Here, the server 2 determines the HTTP request #2 arriving within the maximum threshold time(MAXt) which is from the time HR1, when the HTTP request #1 arrives in the server 2, to HR1′, as one simultaneous HTTP responses group by the time flexible routine T1.

The server 2 also determines the HTTP request #3 arriving within the maximum threshold time(MAXt), which is from the time HR2, when the HTTP request #2 arrives in the server 2, to HR2′, as one simultaneous HTTP responses group by the time flexible routine T1.

On other hand, the server 2 cannot determine the HTTP request #4 not arriving within the maximum threshold time(MAXt), which is from the time HR3, when the HTTP request #3 arrives in the server 2, to HR3′, as one simultaneous HTTP responses group. The HTTP request #4 is later reverified by the reverification routine T3

When the client authentication value C included in the cookie is identical to the second server authentication value S2 in the serer 2, the server 2 performs a pseudo code module T2 which is an update routine. A random number corresponding to the second server authentication value S2 is stored in the client 1 and a new random number is generated in the server 2. The second server authentication value S2 is then copied to the first server authentication value S1. A value calculated with the predetermined function by employing the new random number and the shared key K in the second server authentication value S2 is stored. The timestamp stores a current time and the counter is initialized to zero. The HTTP response including the new random number R generated in the server 2 is transmitted to the client 1.

When the conditions described above are not satisfied, the server 2 performs the pseudo code module T3 which is the reverification routine. The reverification routine includes repeat routine F1, time routine F2 and delete routine F3.

In the repeat routine F1, the server 2 transmits the HTTP response including an executable code(for example, client side script, flash, activeX etc. for convenience, client side script, flash, activeX will be referred to collectively as CFA) to immediately conduct the HTTP request for requesting the random number R, which the server 2 stores by increasing the counter by 1, and a new client authentication value C, which the client 1 calculates by employing the random number R and the shared key K stored in the client 1, to the client 1 in Step 78. This HTTP response is defined as CFA response. The verification timestamp TV stores current time.

The client 1 stores the new client authentication value C calculated using the random number received in Step 78 according to the received CFA response in the cookie or transmits a HTTP request including the cookie in a get or post form to the server 2 in Step 79.

This repeats for an appropriate number of times till an authentication is successful in the repeat routine F1. Here, the appropriate number of times is a value stored in the maximum threshold counter(MAXc).

Even though it exceeds the appropriate number of times, the server 2 performs the time routine F2 and transmits the HTTP response including the executable code(for example, client side script, flash, activeX, etc.) to immediately request the random number R stored in the server 2 and the new client authentication value C, which the client 1 calculated by employing the random number R and the shared key K stored in the client 1, to the client 1, if ctime( )-verification timestamp TV is within the maximum threshold time(MAXv).

When the authentication is failure by the repeat routine F1 and the time routine F2, it is finally determined as authentication failure and the user session is deleted(delete routine F3) and the user is logged out.

When the user is logged out or logs out, the server 2 deletes user session maintaining information such as shared key K, constants(MAXt, MAXc, MAXv), variables(counter, TS, TV), random number R, server authentication values(S1, S2). The server 2 transmits client side script, flash or activeX to the client 1 to set the shared key K, the random number R, the cookie, etc stored in the certain storage space of the client 1 to NULL.

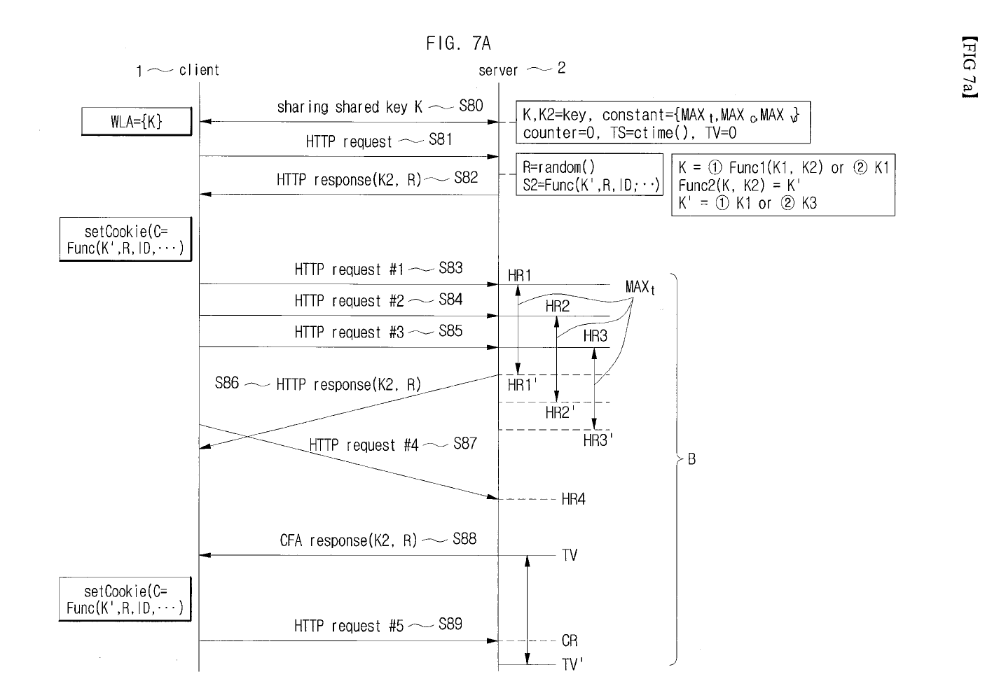

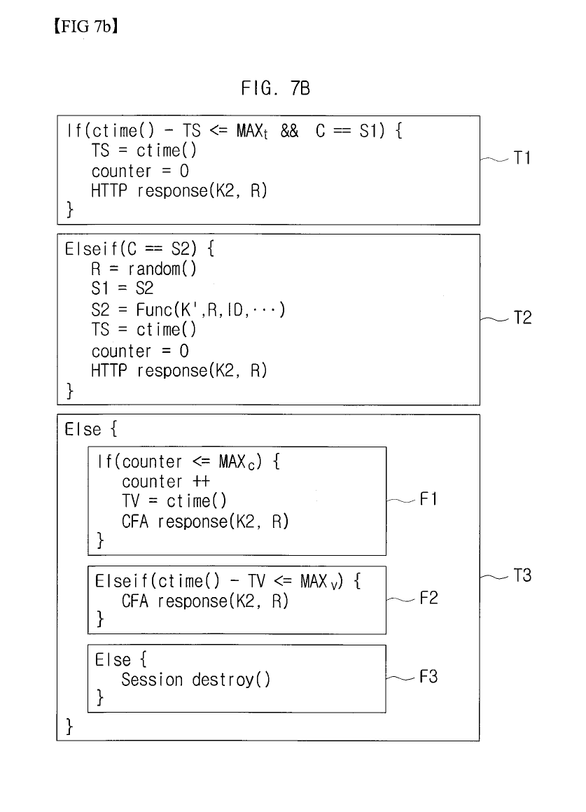

FIG. 7a illustrates a secure user session managing method according to another embodiment of the present invention and FIG. 7b is a pseudo code executing in the server of FIG. 7a.

According to another embodiment as shown in FIGS. 7a and 7b, a secure key K′ is generated by employing a shared key K and a key transfer factor K2, a client authentication value and a server authentication value are calculated by using the secure key K′, while the shared key K is directly used to obtain the client authentication value as shown in FIGS. 6a and 6b. Use of the key transfer factor has been described with referring to FIG. 4 and the detailed explanation is thus omitted.

The user session managing method of the present invention is operatable with computer programs. It is obvious that codes and code segments for such computer programs can easily be drawn by computer programmer in the field of art. Such computer programs may be stored in a computer readable media which the computer is able to read, be read by the computer, and provide services. The computer readable media may include magnetic readable media, optical readable media and carrier wave media.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A user session managing method in a server which is connected with a client through a network, the method comprising:
allowing the server to receive a first HTTP request including a cookie from the client, wherein the cookie includes a client authentication value and the client authentication value is calculated by using a shared key stored in the client and session information included in a HTTP response transmitted right before to the client;
comparing a server authentication value with the client authentication value included in the cookie, wherein the server authentication value is calculated by employing the session information and the shared key stored in the server; and
determining a transmitter's authentication failure or success of the client according to the result of the comparison.

2. The method of claim 1, wherein the determining a transmitter's authentication failure or success comprises:
considering as valid for the user session and updating the session information when the server authentication value is identical to the client authentication value, calculating a server authentication value corresponding to the updated session information, and transmitting a second HTTP response for the first HTTP request including the updated session information, to the client,
allowing the second HTTP responses to calculate a client authentication value with a one-way function by employing the shared key stored in the client and the session information included in the second HTTP response, and comprise an executable code allowing the client authentication value to be included in the cookie.

3. The method of claim 1, wherein the determining a transmitter's authentication failure or success comprises:
allowing the server to consider as invalid for the user session and delete the user session when the server authentication value is different from the client authentication value, and
allowing the server to transmit client side script, flash or activeX to set at least one selected from the group consisting of the shared key of the client, the session information, the client authentication value, and the cookie to NULL, to the client.

4. The method of claim 1, wherein the session information is a random number.

5. The user session managing method of claim 1, wherein the session information is a random number and a key transfer factor.

6. The user session managing method of claim 5, wherein
the server authentication value is calculated with a one-way function by employing the random number and the server secure key obtained by using the shared key stored in the server and the key transfer factor,
the client authentication value is calculated with a one-way function by employing the client secure key, obtained by using the shared key stored in the client and the key transfer factor included in the first HTTP response which the client received from the server, and the random number included in the first HTTP response.

7. The user session managing method of claim 1, wherein the server transmits the first HTTP response including client side script, flash or activeX to encrypt and decrypt a part of HTTP contents using the shared key during the first HTTP response, to the client.

8. The user session managing method of claim 1, wherein the server further transmits the HTTP response including an encryption routine that the client is able to encrypt a part of HTTP contents, to the client,
wherein the client transmits the first HTTP request, in which a part of the HTTP contents is encrypted by using the shared key according to the encryption routine, to the server.

9. A user session managing method in a server which is connected with a client through a network, the method comprising:
calculating a first server authentication value by employing a random number already generated by the server and a shared key stored in the server;
generating a new random number;
calculating a second server authentication value by employing the random number and the shared key stored in the server;
transmitting a HTTP response including the random number to the client;
receiving a HTTP request including a cookie from the client, wherein the cookie includes a client authentication value, the client authentication value is obtained by employing the shared key stored in the client and the random number included in the HTTP response transmitted to the client; and
determining a transmitter's authentication failure or success of the client according to the result of the comparison of one of the first server authentication value and the second server authentication value with the client authentication value.

10. The user session managing method of claim 9, wherein the determining process further comprises:
determining as authentication success when the client authentication value is identical to the first server authentication value and an arriving time of the HTTP request is prior to passing a certain period of time from an arriving time of a right before HTTP request; and
transmitting the HTTP response including the random number used to calculate the second server authentication value to the client.

11. The user session managing method of claim 9, wherein the determining process further comprises:
determining as authentication success when the client authentication value is identical to the second server authentication value,
generating a new random number;
coping the second server authentication value to the first server authentication value;
updating the second server authentication value using the new generated random number and the shared key stored in the server; and
transmitting the HTTP response including the new generated random number to the client.

12. The user session managing method of claim 9, wherein the determining process further comprises:
determining as authentication failure when the client authentication value is different from the first sever authentication value and the second server authentication value,
transmitting the HTTP response including the random number and an executable code to immediately conduct the HTTP request for requesting a new client authentication value which the client calculates by employing the random number and the shared key stored in the client.

13. The user session managing method of claim 12, wherein the transmitting the HTTP response including the random number and the executable code is repeated a particular number of times.

14. The user session managing method of claim 13, wherein the transmitting the HTTP response including the random number and the executable code is repeated for a certain period of time after repeating a particular number of times.

15. The user session managing method of claim 14, the method further comprising deleting the user session after the certain time.

16. The user session managing method of claim 9, wherein the first server authentication value and the second server authentication value are obtained with a one-way function of the random number and the server secure key generated by using the shared key stored in the server and key transfer factor,
wherein the key transfer factor is included in the HTTP response in the transmitting the HTTP response to the client.

17. A user session managing method in a client which is connected with a server through a network, the method comprising:
allowing the client to share the server and a shared key;
storing the shared key in window.name, local shared object(LSO) of flash or activeX among window object properties of document object model(DOM) of a web browser;
receiving a HTTP response from the server, wherein the HTTP response includes session information generated in the server;
calculating a client authentication value by employing the session information and the shared key; and
storing the client authentication value at a cookie.

18. The user session managing method of claim 17, the method further comprising transmitting a HTTP request including the cookie to the server with the HTTP request requesting for the transmitter's authentication.

19. The user session managing method of claim 17, wherein the client authentication value is calculated with a one-way function by employing the session information and the shared key.

20. The user session managing method of claim 17, wherein the session information is a random number.

21. The user session managing method of claim 17, wherein the session information comprises a random number and a key transfer factor.

22. The user session managing method of claim 21, wherein the client authentication value is calculated with a one-way function by employing the client secure key, calculated by employing the shared key stored in the client and the key transfer factor, and the random number included in the HTTP response.

23. The user session managing method of claim 17, wherein the session information is stored in the storage space where the shared key is stored.

24. The user session managing method of claim 23, the method further comprising receiving 2 or more of HTTP responses from the server, wherein
the already generated cookie is reused when the session information included in the 2 or more of HTTP responses is identical to that stored in the storage space, and
the session information stored in the storage space is updated, the client authentication value is recalculated by employing the updated session information, and the cookie is newly generated when the session information included in the 2 or more of HTTP responses is different from that stored in the storage space.

25. The user session managing method of claim 23, the method further comprising transmitting each of the 2 or more of HTTP requests commonly including a cookie which includes a client authentication value generated by employing the session information stored in the storage space, to the server, when 2 or more of HTTP requests are requested for the transmitter's authentication within a particular time.
